(19) United States
(12) Patent Application Publication
(10) Pub. No.: US 2008/0243830 A1
(43) Pub. Date: Oct. 2, 2008

(54) User suggested ordering to influence search result ranking

(75) Inventor: Raj Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/891,885

(22) Filed: Aug. 13, 2007

Related U.S. Application Data
(60) Provisional application No. 60/921,339, filed on Mar. 30, 2007.

(51) Int. Cl. G06F 17/30

(52) U.S. Cl. 707/5; 707/E17.108

(57) ABSTRACT

A method, apparatus, and system of user suggested ordering to influence search result ranking are disclosed. In one embodiment, a method includes generating a search result having a set of links each associated with a content data relevant to a search query, ranking individual ones of the set of links based on an algorithm in the search result, applying a weighting factor to certain ones of the set of links based on a user suggested ordering of the ranking of the individual ones of the set of links in relation to each other, and ordering the search result based on an application of the weighting factor on the search result.

### CLAIMS OF PRIORITY

This patent application claims priority to U.S. Provisional patent application No. 60/921,339, titled ‘User suggested ordering to influence search result ranking’ filed on Mar. 30, 2007.

### FIELD OF TECHNOLOGY

This disclosure relates generally to the technical fields of communications and, in one example embodiment, to a method, apparatus, and system of user suggested ordering to influence search result ranking.

### BACKGROUND

A search engine (e.g., Google®, Yahoo®, YouTube®, MSN®, Amazon®, Wikipedia®, Wikia®, Spock®, A9®, Froogle®, etc.) may use an algorithm (e.g., page rank, alphabetical, time based, influence based, credibility, etc.) to determine an order in which search results are displayed (e.g., which links are listed first, second, third, etc.). The search engine may seek to deliver more relevant search results to a user through the algorithm.

For example, Google® (e.g., the search engine) may use the page rank algorithm to determine the order in which various links (e.g., website URLs) are displayed when a user enters ‘online education’ in a search query. The page rank algorithm may consider how many other websites link to a particular link in determining an order in which the various links are displayed (e.g., to determine a relevancy, popularity, influence, etc. of the particular link). However, professional Search Engine Optimization (SEO) companies may artificially influence placement of the particular link by mass exchanging the particular link with other websites to increase references back.

In addition, the search engine may consider which of the various links previous users had clicked on when they also entered ‘online education’. For example, if previous users had clicked more on a third link in the search results, that link may later move up in ranking of future search results. However, the user may have clicked on the third link only because it was listed earlier in the search results and/or because the snippet text in the search results was not clear as to what the content of the website referenced by the third link contained.

The search engine may also consider credibility of a particular website. For example, Google® may place more weight when the third link is shown on a first page of search results on Yahoo® (e.g., the particular website) than when it shown on a first page of a link aggregator website (e.g., owned by the SEO company). However, credibility of a website may not reflect whether content in the particular link is credible with an average user.

The search engine may consider a length of time a particular domain (e.g., a domain associated with the link) has been registered. The search engine may give more credence in search rankings to domains (e.g., websites and/or web pages, etc.) which have been in existence for a longer period of time as opposed to ones which have been in existence for shorter periods of time. However, sometimes, most relevant content may just be on the domains which were most recently created.

The search engine may give more preference to websites that have higher percentages of user generated content by placing them higher in the search result. For example, Wikipedia® or Fatdoor® may show up higher in a search result than other websites because they may include more user generated content. However, there may be other links in the search result which have content that is more relevant than the sites having the user generated content.

Some websites may employ human editors to aid in search result rankings and/or relevancy (e.g., Yahoo®, Wikia®, etc.). However, such a model may not provide a voice to whether any particular link was relevant to the average user. In addition, on certain websites users may vote on whether a particular review was helpful to them (e.g., Yelp®, Amazon®, etc.). However, such a model may merely look at the particular review in isolation and may not consider the relative order in which any particular review was more or less helpful than reviews appearing immediately above or below the particular review.

The other websites may seek to create ‘specialized’ search engines to improve results in a particular vertical. For example, YouTube® may be specific for those searching for videos, while Froogle® may be specific for those searching for deals, and Spock® may be specific to those searching for people. However, the users may have to go to different websites to search for different categories of items and this can be a time consuming and/or a frustrating task.

As a result, the search results through current search engines (e.g., Google®, Yahoo®, MSN®, Ask®, Amazon®, Yelp®, Spock® etc.) do not provide a way for the users to express their personal relevance that can contribute to overall relevance. For example, the first two and/or three pages on the Google®, Yahoo®, and Ask® search results page for ‘online education’ today are filled with links to link aggregator websites (e.g., websites which may get paid to provide referrals).

### SUMMARY

A method, apparatus and system of user suggested ordering to influence search result ranking are disclosed. In one aspect, a method includes generating a search result having a set of links, each associated with a content data relevant to a search query, ranking individual ones of the set of links based on an algorithm (e.g., a page rank algorithm, an influence based algorithm, a human editor rank algorithm, a temporal existence algorithm, a user-generated content premium algorithm, and/or a specialized category search algorithm, etc.) in the search result, applying a weighting factor to certain ones of the set of links based on a user suggested ordering of the ranking of the individual ones of the set of links in relation to each other, and ordering the search result based on an application of the weighting factor on the search result.

The method may further include mathematically determining an influence of any individual one of the user suggested ordering in relation to other user suggested reordering requests based on a polymeric function that optimizes a relevance of the search result to an average user generating the search query. The method may also include balancing the weighting factor against a quantity of search queries in which there was no user suggested ordering requested during search sessions. The method may yet include providing an up arrow and a down arrow in each individual one of the set of links so that the average user clicks on at least one of the up arrow and the down arrow to see a requested movement above and/or below other individual ones of the set of links. In addition, the method may include generating a count of a number of times that the average users select the up arrow and the down arrow such that the count is visually displayed during a search experience of the average user.

The method may further include providing recognition to the average user in helping to order the search result in a form of points viewable by other users of a search engine. The method may also include enabling the average user to select a page in which any particular link is suggested to be moved by the average user. The method may also include determining a relative influence of the average user with other average users based on an algorithmic scoring of influence of the average user on future search results conducted on shuffled data without receiving move requests by users to determine a relative alignment of the average user with relevancy to a popular outcome of the search query. The method may yet include providing a pointer to shuffled links such that even when the algorithm is rerun, the pointer provides a context of previous order preferences of a community of users in relation to other links in the refreshed search query.

In another aspect, a system includes a user influence module to shuffle a search result based on a weighted preference of relevant links as determined by users contributing a perspective on relative order of the search result, a function module to apply a page rank algorithm in determining a relative order of links in the search result responsive to a search query, a factor module to apply a weighting factor to individual links in the search result such that certain ones of the individual links may be prioritized before other links, and a search module to generate the search result that dynamically adjusts as different users contribute perspectives through the user influence module.

The system may further include an advertising module to embed certain links adjacent to the search result based on bidding between advertisers seeking impressions adjacent to the search result. The system may also include a category search module to enhance relevancy of the search results based on a category being searched through an application of different algorithms optimized to a category search employed. The system may yet include a claimable wiki module to embed in the search results, a section relevant to the search query associated with a claimable people profile wiki, a business profile wiki, an organization claimable profile wiki, a places wiki, and/or an other object wiki.

In addition, the system may include a pointer module to index and/or capture shuffled links across iterations of the search query with a search algorithm and a refresh module to apply the pointer module each time the search algorithm is reapplied even when certain links in the search result are activated, deactivated, modified, added, and/or deleted based on a re-indexing of Internet through the search algorithm.

In yet another aspect, a method includes providing an interface in a search result that empowers each individual user to suggest where a particular listing in the search result is preferably placed, previewing each listing such that a summary text enables each individual user to make an informed placement selection, and generating a new search result based on a plurality of suggestions provided by the individual users through an algorithm that determines a relative weight of any one search movement request with each other.

The method may further include applying a page ranking algorithm to determine the search result on a periodic basis while retaining an influence of the aggregate relative weight influence of the individual users providing feedback on specific links in the search result. The method may also include determining which of the individual users are more in line with a model average user based on an analysis of users not challenging a shuffled ranking order.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a central module communicating with client devices through a network, according to one embodiment.

FIG. 2 is a user interface view of a Google® search result page, according to one embodiment.

FIG. 3 is a user interface view of a Yahoo® search result page, according to one embodiment.

FIG. 4 is a user interface view of an Amazon® search result page, according to one embodiment.

FIG. 5 is a user interface view of a MSN® search result page, according to one embodiment.

FIG. 6 is a user interface view of an Ask® search result page, according to one embodiment.

FIG. 7 is a user interface view of a Yelp® search result page, according to one embodiment.

FIG. 8 is a user interface view of a YouTube® search result page, according to one embodiment.

FIG. 9 is a user interface view of the central module illustrating ordering of events in a neighborhood, according to one embodiment.

FIG. 10 is a user interface view of the central module illustrating ordering of deals in the neighborhood, according to one embodiment.

FIG. 11 is a user interface view of the central module illustrating ordering of matched profiles, according to one embodiment.

FIG. 12 is a user interface view of the central module illustrating ordering of comments associated with a user profile, according to one embodiment.

FIG. 13 is a diagrammatic system view of a data processing system in which any of the embodiments disclosed herein may be performed, according to one embodiment.

FIG. 14 is a table view displaying ranking details of various links in a search result, according to one embodiment.

FIG. 15 is a schematic representation of a typical relationship between three hypertext documents and the user influence module, according to one embodiment.

FIG. 16 is an example formula using a page rank algorithm, according to one embodiment.

FIG. 17 is a schematic representation of a ranking method of hypertext documents using the user influence module, according to one embodiment.

FIG. 18 is a process flow of a computer implemented method for calculating an importance rank for N linked nodes, according to one embodiment.

FIG. 19A is a process flow of generating a user suggested ordering of links in a search result, according to one embodiment.

FIG. 19B is a continuation of the process flow of FIG. 19A illustrating additional processes, according to one embodiment.

FIG. 20 is a process flow of providing an interface to shuffle the search result, according to one embodiment.

Other features of the present embodiments will be apparent from the accompanying drawings and from the detailed description that follows.

### DETAILED DESCRIPTION

A method, apparatus and system of user suggested ordering to influence search result ranking are disclosed. In the following description, for the purposes of explanation, numerous specific details are set forth in order to provide a thorough understanding of the various embodiments. It will be evident, however to one skilled in the art that the various embodiments may be practiced without these specific details.

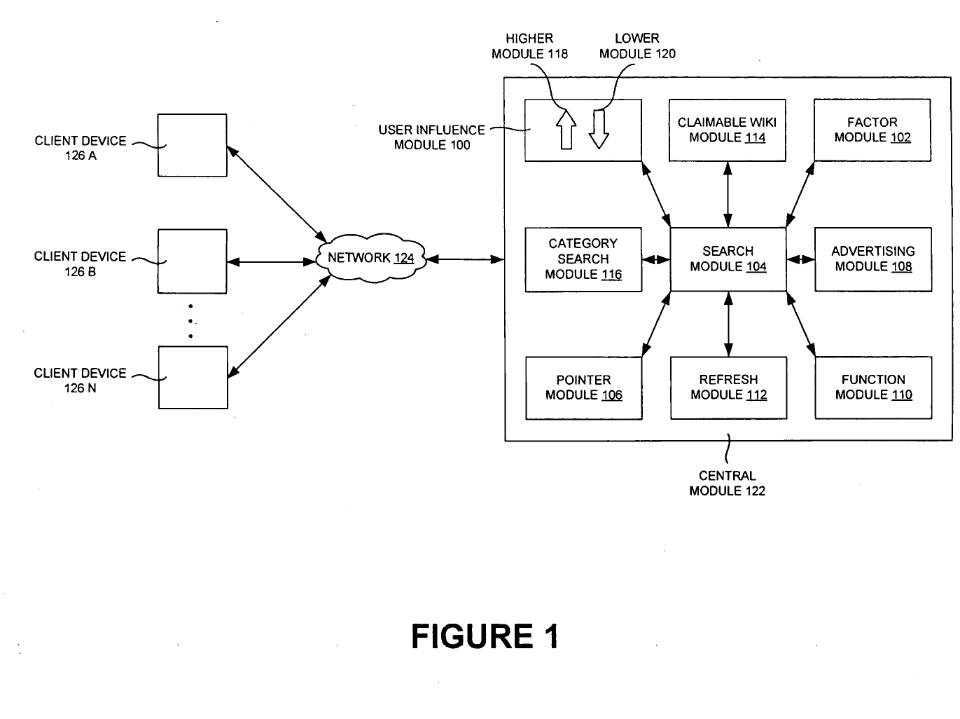

In one embodiment, a method includes generating a search result (e.g., using the search module 104 of FIG. 1) having a set of links, each associated with a content data relevant to a search query, ranking individual ones of the set of links based on an algorithm (e.g., applied using the function module 110 of FIG. 1) in the search result, applying a weighting factor (e.g., using the factor module 102 of FIG. 1) to certain ones of the set of links based on a user suggested ordering of the ranking of the individual ones of the set of links in relation to each other, and ordering the search result based on an application of the weighting factor on the search result.

In another embodiment, a system includes a user influence module (e.g., the user influence module 100 of FIG. 1) to shuffle a search result based on a weighted preference of relevant links as determined by users contributing a perspective on the relative order of the search result, a function module (e.g., the function module 110 of FIG. 1) to apply a page rank algorithm in determining a relative order of links in the search result responsive to a search query, a factor module (e.g., the factor module 102 of FIG. 1) to apply a weighting factor to individual links in the search result such that certain ones of the individual links are prioritized before other links, and a search module (e.g., the search module 104 of FIG. 1) to generate the search result that dynamically adjusts as different users contribute perspectives through the user influence module 100.

In yet another embodiment, a method includes providing an interface (e.g., through the user influence module 100 of FIG. 1) in a search result that empowers each individual user to suggest where a particular listing in the search result is preferably placed, previewing each listing such that a summary text enables each individual user to make an informed placement selection, and generating a new search result (e.g., using the refresh module 112 of FIG. 1) based on suggestions provided by the individual users through an algorithm that determines a relative weight of any one search movement request with each other.

FIG. 1 is a system view of a central module 122 communicating with client devices 126A-N through a network 124, according to one embodiment. Particularly, FIG. 1 illustrates a user influence module 100, a factor module 102, a search module 104, a pointer module 106, an advertising module 108, a function module 110, a refresh module 112, a claimable wiki module 114, a category search module 116, a higher module 118, a lower module 120, the central module 122, the network 124 and the client devices 126A-N, according to one embodiment.

The user influence module 100 may enable average users to contribute a new perspective on the relative order of a search result as determined by other users based on a weighted preference of various links. The factor module 102 may apply a weighting factor to individual links in the search result to prioritize certain links based on user suggested ordering. The search module 104 may generate the search result that dynamically adjusts according to the new perspective of the average users. The pointer module 106 may capture shuffled links in the search result such that a pointer provides a context of previous order of the various links in a refreshed search result. The advertising module 108 may embed certain links (e.g., an advertisement link) adjacent to the various links during generation of the search result.

The function module 110 may apply an algorithm (e.g., a page rank algorithm, an influence based algorithm, a human editor rank algorithm, a temporal existence algorithm, a user-generated premium algorithm and/or a specialized category search algorithm, etc.) to determine a relative order of the various links in the search result. The refresh module 112 may apply the pointer module 106 to capture all shuffled links even when certain links are activated, deactivated, modified, added and/or deleted in a user influenced search result.

The claimable wiki module 114 may provide a wiki interface (e.g., a people profile wiki, a business profile wiki, an organization profile wiki and/or a places wiki, etc.) generated in the search result along with the various links. The category search module 116 may enable a category based search using the algorithm (e.g., the specialized category search algorithm) to generate accurate and/or relevant search results.

The higher module 118 may enable the average users to move a particular link upwards in the search result for obtaining the user influenced search result. The lower module 120 may enable the average users to move the particular link downwards in the search result for obtaining the user influenced search result. The central module 122 may coordinate ranking of the various links and/or generation of the user suggested search result through the user influence module 100. The network 124 may facilitate communication between the central module 122 the client devices 126A-N. The client devices 126A-N may be a personal computer, a cell phone, PDA, etc. used by the average users to obtain the user influenced search result through the central module 122.

In the example embodiment illustrated in FIG. 1, the central module 122 communicates with the client devices 126A-N through the network 124. The central module 122 consists of the user influence module 100, the factor module 102, the search module 104, the pointer module 106, the advertising module 108, the function module 110, the refresh module 112, the claimable wiki module 114, the category search module 116, the higher module 118 and the lower module 120, communicating with each other.

For example, the search result having a set of links each associated with a content data relevant to a search query may be generated (e.g., using the search module 104 of FIG. 1) and individual ones of the set of links may be ranked based on the algorithm (e.g., a page rank algorithm, a influence based algorithm, a human editor rank algorithm, a temporal existence algorithm, a user-generated content premium algorithm, and/or a specialized category search algorithm, etc.) in the search result. The weighting factor may be applied (e.g., using the factor module 102 of FIG. 1) to certain ones of the set of links (e.g., based on the user suggested ordering of the ranking of the individual ones of the set of links in relation to each other).

The search result may be ordered based on an application of the weighting factor (e.g., using the factor module 102 of FIG. 1) on the search result. An influence of any individual one of the user suggested ordering may be determined mathematically in relation to other user suggested reordering requests based on a polymeric function that optimizes a relevance of the search result to an average user generating the search query. The weighting factor may be balanced against a quantity of search queries in which there was no user suggested ordering requested during search sessions.

A recognition may be provided to the average user in helping to order the search result in a form of points viewable by the other users of the search engine (e.g., Google®, Yahoo®, YouTube®, MSN®, Amazon®, Wikipedia®, Wikia®, Spock®, A9®, Froogle®, etc.). For example, the average user may be enabled to select a page in which any particular link is suggested to be moved by the average user. A relative influence of the average user with other average users may be determined (e.g., based on an algorithmic scoring of influence of the average user on future search results conducted on shuffled data without receiving move requests by users to determine a relative alignment of the average user with relevancy to a popular outcome of the search query).

The pointer may be provided (e.g., through the pointer module 106 of FIG. 1) to shuffled links such that even when the algorithm is rerun, the pointer provides the context of previous order preferences of a community of users in relation to other links in the refreshed search query. The user influence module 100 may shuffle the search result based on the weighted preference of relevant links as determined by the users contributing the perspective on the relative order of the search result. The function module 110 may apply the page rank algorithm in determining the relative order of links in the search result responsive to the search query.

The factor module 102 may apply a weighting factor to individual links in the search result such that certain ones of the individual links are prioritized before other links. The search module 104 may generate a search result that dynamically adjusts as different users contribute perspectives through the user influence module 100. The advertising module 108 may embed certain links adjacent to the search result based on bidding between advertisers seeking impressions adjacent to the search result. The category search module 116 may enhance relevancy of the search results based on a category being searched through an application of different algorithms optimized to a category search employed.

The claimable wiki module 114 may embed in the search results, a section relevant to the search query associated with a claimable people profile wiki, a business profile wiki, an organization claimable profile wiki, a places wiki, and/or an other object wiki. The pointer module 106 may index and/or capture shuffled links across iterations of the search query with a search algorithm (e.g., the category search algorithm). The refresh module 112 may apply the pointer module each time the search algorithm is reapplied even when certain links in the search result are activated, deactivated, modified, added, and/or deleted based on a re-indexing of Internet through the search algorithm. For example, it may be determined which of the individual users are more in line with a model average user based on an analysis of users not challenging a shuffled ranking order.

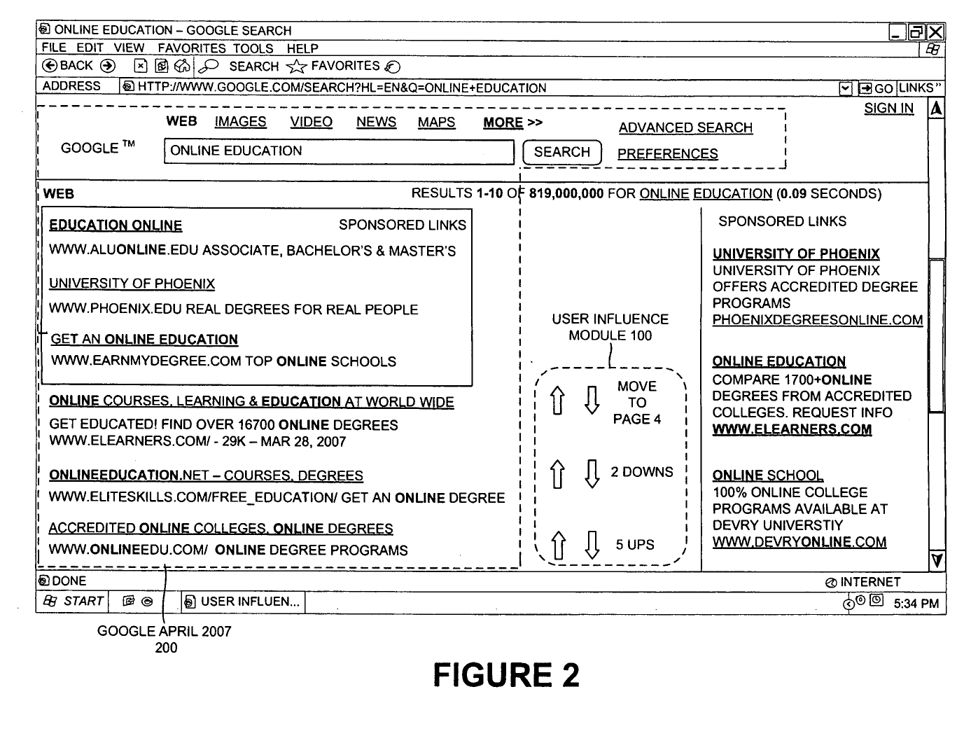

FIG. 2 is a user interface view of a Google® search result page, according to one embodiment. Particularly, FIG. 2 illustrates the user influence module 100 and a Google® April 2007 search result link 200, according to one embodiment.

The user influence module 100 may enable the average users to make changes in order of links in the Google® April 2007 search result link 200 by using an up arrow and/or a down arrow. The Google® April 2007 search result link 200 may be a search result link obtained when any user enters a particular search keyword (e.g., online education) in Google® search engine.

In the example embodiment illustrated in FIG. 2, the user interface view displays the user influence module 100 which allows the average users to rank individual links in the Google® April 2007 search result link 200. The average users may use the up arrow and/or the down arrow of the user influence module 100 to move required links to a particular page (e.g., from page 1 to page 4 of the search result page). The user interface view also displays a count of a number of times the average users have moved a particular link upwards and/or downwards during search sessions.

The up arrow and the down arrow may be provided (e.g., using the higher module 118 and the lower module 120 of FIG. 1) in each individual one of the set of links so that the average user clicks on the any one of the up arrow and the down arrow to see a requested movement above and/or below other individual ones of the set of links. The count of the number of times that the average users select the up arrow and the down arrow may be generated such that the count is visually displayed during a search experience of the average user.

The interface may be provided in the search result that empowers each individual user to suggest where a particular listing in the search result is preferably placed. Each listing may be previewed such that a summary text enables each individual user to make an informed placement selection. A new search result may be generated (e.g., using the refresh module 112 of FIG. 1) based on suggestions provided by the individual users through the algorithm that determines a relative weight of any one search movement request with each other.

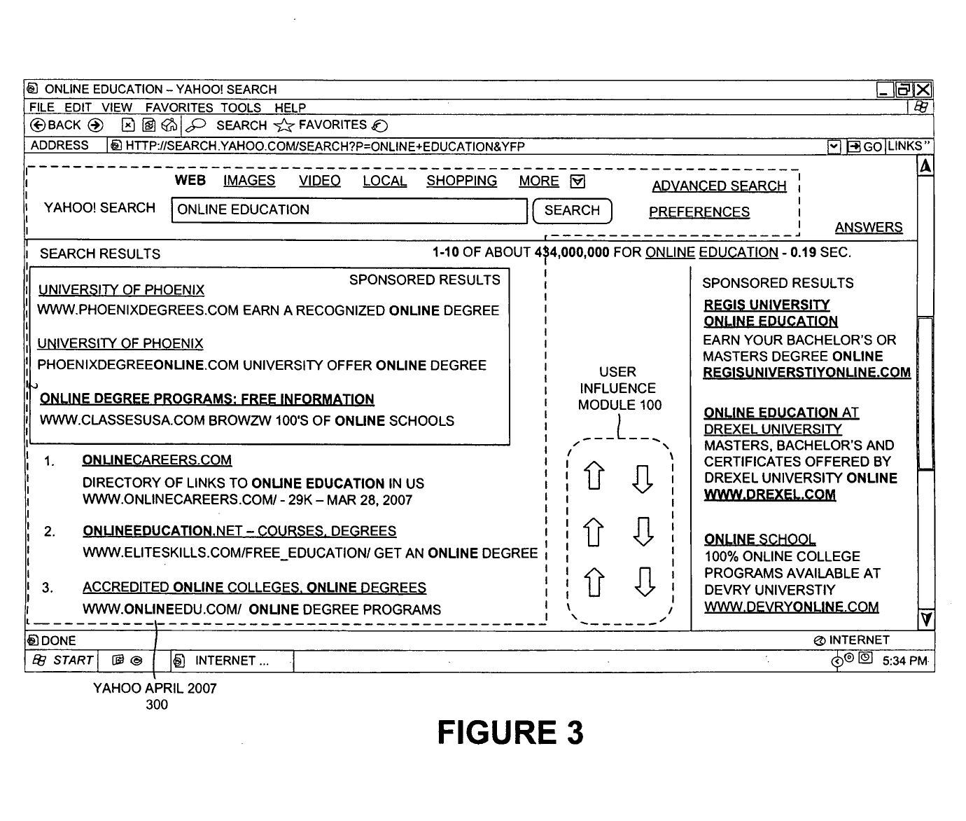

FIG. 3 is a user interface view of a Yahoo® search result page, according to one embodiment. Particularly, FIG. 3 illustrates the user influence module 100 and a Yahoo® April 2007 search result link 300, according to one embodiment.

The user influence module 100 may enable the average users to make changes in order of links in the Yahoo® April 2007 search result link 300 by using the up arrow and/or the down arrow. The Yahoo® April 2007 search result link 300 may be a search result link obtained when any user enters a particular search keyword (e.g., online education) in Yahoo® search engine.

In the example embodiment illustrated in FIG. 3, the user interface view displays the user influence module 100 which allows the average users to rank individual links in the Yahoo® April 2007 search result link 300 to obtain the user influenced search result. The user interface view also displays certain sponsored results (e.g., the advertisement link) generated along with the search result through the advertising module (e.g., the advertising module 108 of FIG. 1).

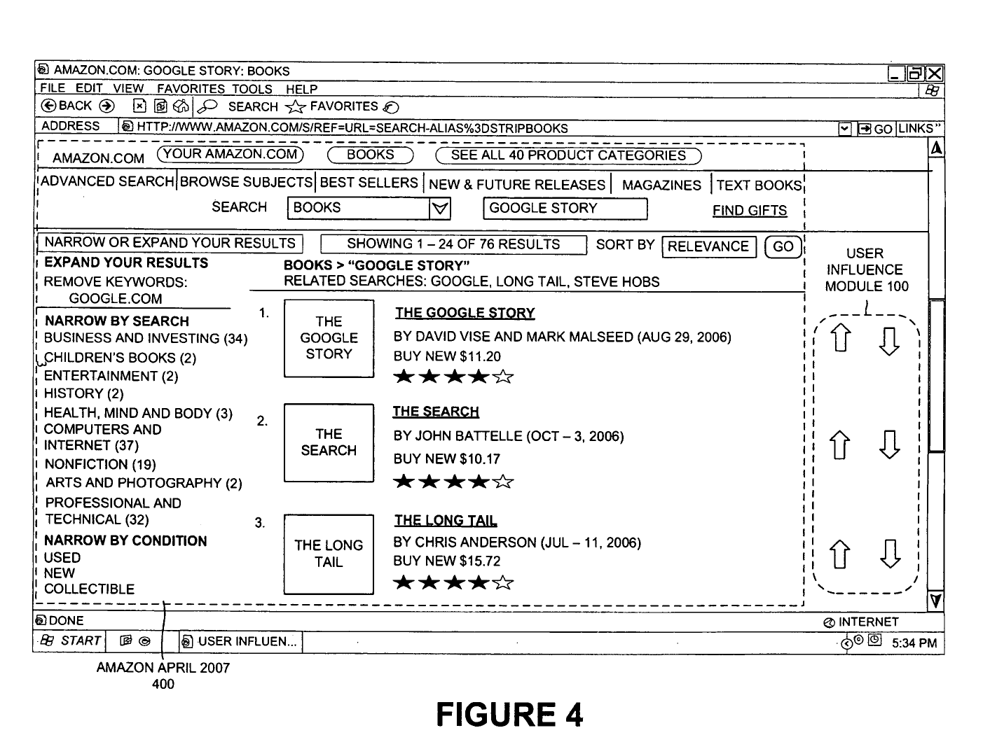

FIG. 4 is a user interface view of an Amazon® search result page, according to one embodiment. Particularly, FIG. 4 illustrates the user influence module 100 and an Amazon® April 2007 search result link 400, according to one embodiment.

The user influence module 100 may enable the average users to make changes in order of links in the Amazon® April 2007 search result link 400 by using the up arrow and/or the down arrow. The Amazon® April 2007 search result link 400 may be a search result link obtained when any user enters a particular search keyword (e.g., “google story”) in the Amazon® search engine.

In the example embodiment illustrated in FIG. 4, the user interface view displays the user influence module 100 which allows the average users to rank individual links in the Amazon® April 2007 search result link 400 to obtain the user influenced search result. The user interface view also displays a narrow by category link where the users may employ a category search to enhance relevancy of the search result in the Amazon® search result page.

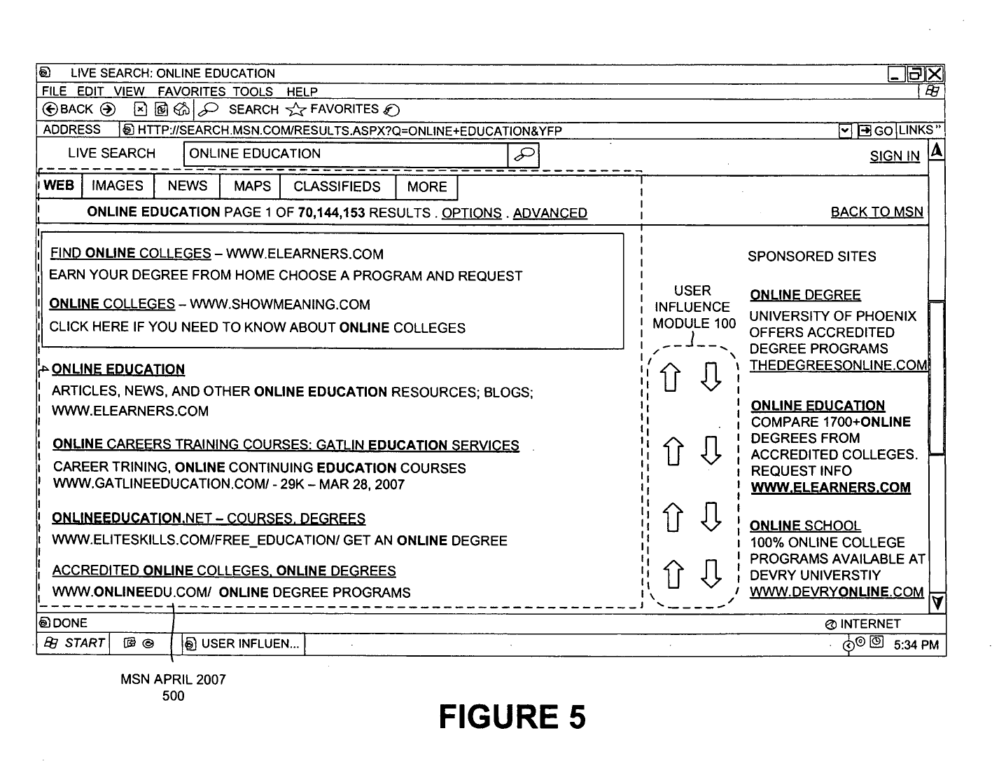

FIG. 5 is a user interface view of a MSN® search result page, according to one embodiment. Particularly, FIG. 5 illustrates the user influence module 100 and a MSN® April 2007 search result link 500, according to one embodiment.

The user influence module 100 may enable the average users to make changes in order of links in the MSN® April 2007 search result link 500 by using the up arrow and/or the down arrow. The MSN® April 2007 search result link 500 may be a search result link obtained when any user enters a particular search keyword (e.g., online education) in MSN® search engine.

In the example embodiment illustrated in FIG. 5, the user interface view displays the user influence module 100 which allows the average users to rank individual links in the MSN® April 2007 search result link 500 to obtain the user suggested ordering in the search result.

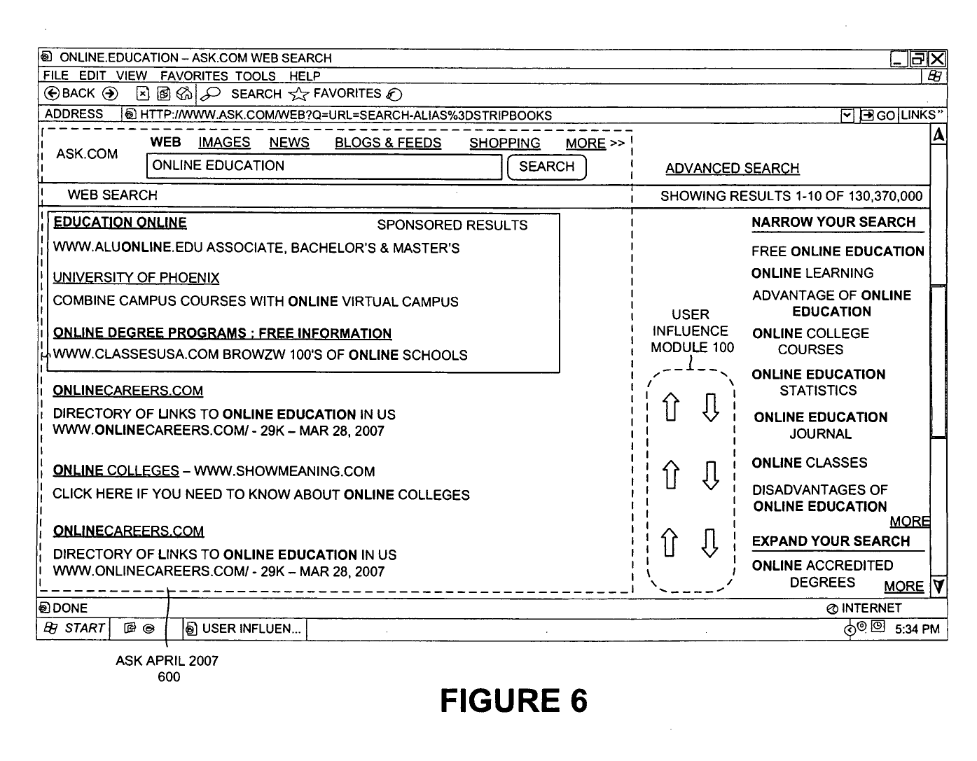

FIG. 6 is a user interface view of an Ask® search result page, according to one embodiment. Particularly, FIG. 6 illustrates the user influence module 100 and an Ask® April 2007 search result link 600, according to one embodiment.

The user influence module 100 may enable the average users to make changes in order of links in the Ask® April 2007 search result link 600 by using the up arrow and/or the down arrow. The Ask® April 2007 search result link 600 may be a search result link obtained when any user enters a particular search keyword (e.g., online education) in Ask® search engine.

In the example embodiment illustrated in FIG. 6, the user interface view displays the user influence module 100 which allows the average users to rank individual links in the Ask® April 2007 search result link 600 to obtain the user influenced search result.

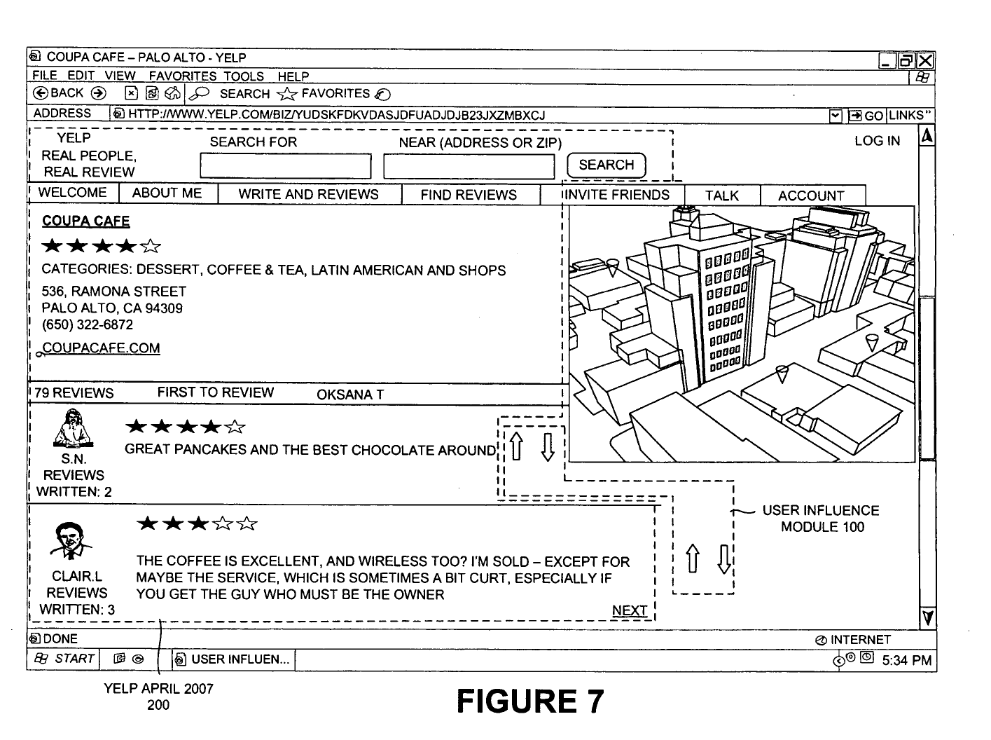

FIG. 7 is a user interface view of a Yelp® search result page, according to one embodiment. Particularly, FIG. 7 illustrates the user influence module 100 and a Yelp® April 2007 search result link 700, according to one embodiment.

The user influence module 100 may enable the average users to make changes in order of links in the Yelp® April 2007 search result link 700 by using the up arrow and/or the down arrow. The Yelp® April 2007 search result link 700 may be a search result link (e.g., related to reviews) obtained when a user enters a particular search keyword (e.g., “Coupa café”) in Yelp® search engine.

In the example embodiment illustrated in FIG. 7, the user interface view displays the user influence module 100 which allows the average users to rank individual links in the Yelp® April 2007 search result link 700 to obtain the user suggested ordering in the search result.

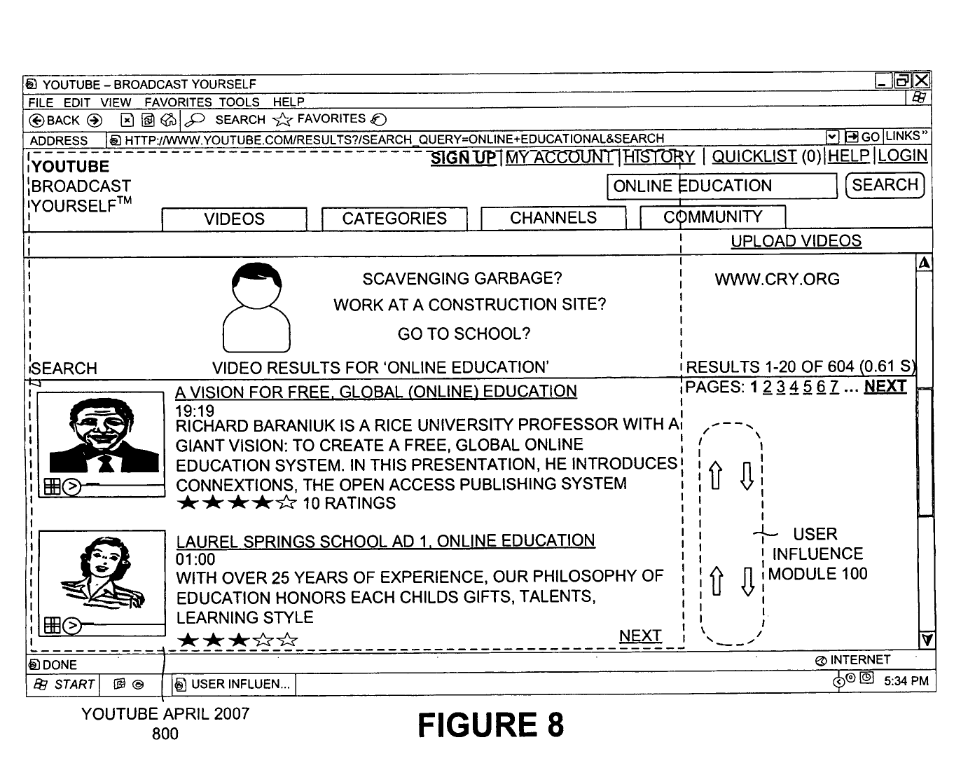

FIG. 8 is a user interface view of a YouTube® search result page, according to one embodiment. Particularly, FIG. 8 illustrates the user influence module 100 and a YouTube® April 2007 search result link 800, according to one embodiment.

The user influence module 100 may enable the average users to make changes in order of links in the YouTube® April 2007 search result link 800 by using the up arrow and/or the down arrow. The YouTube® April 2007 search result link 800 may be a search result link (e.g., video result link) obtained when any user enters a particular search keyword (e.g., online education) in YouTube® search engine.

In the example embodiment illustrated in FIG. 8, the user interface view displays the user influence module 100 which allows the average users to rank individual links in the YouTube® April 2007 search result link 800 to obtain the user suggested ordering of the search result.

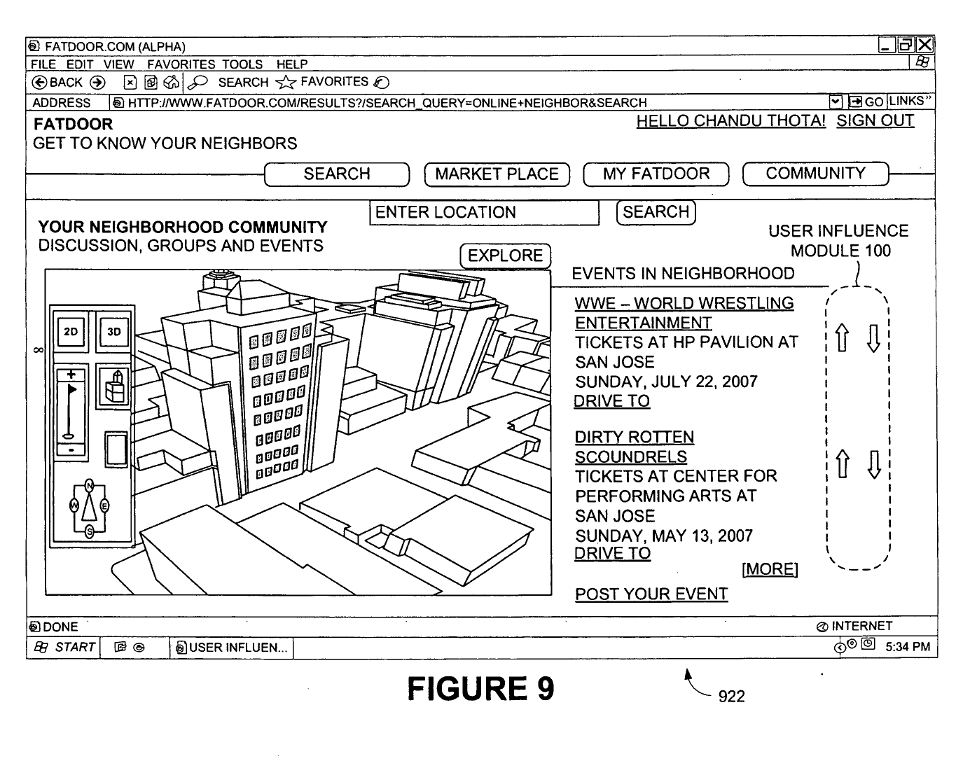

FIG. 9 is a user interface view of a central module 922 illustrating ordering of events in a neighborhood, according to one embodiment. Particularly, FIG. 9 illustrates the user influence module 100, according to one embodiment. The user influence module 100 may enable the average users to shuffle a search result obtained in a Fatdoor® webpage based on a weighted preference of relevant links by the average users to obtain a accurate and/or relevant search result.

In the example embodiment illustrated in FIG. 9, the user interface view displays the Fatdoor® webpage where the users may visualize their neighborhood in a three dimensional map based on a search keyword (e.g., a location) provided by users. The central module 922 may enable a user generated content to be included in the Fatdoor® webpage (e.g., using the factor module 102, the search module 104, the pointer module 106, the advertising module 108, the function module 110, the refresh module 112, the claimable wiki module 114, the category search module 116, the higher module 118 and the lower module 120). The webpage also displays a list of events in the neighborhood that are posted by various users. The users may rank the posted events (e.g., comments) based on a weighted preference of the comments using the up arrow and/or the down arrow provided in the user influence module 100.

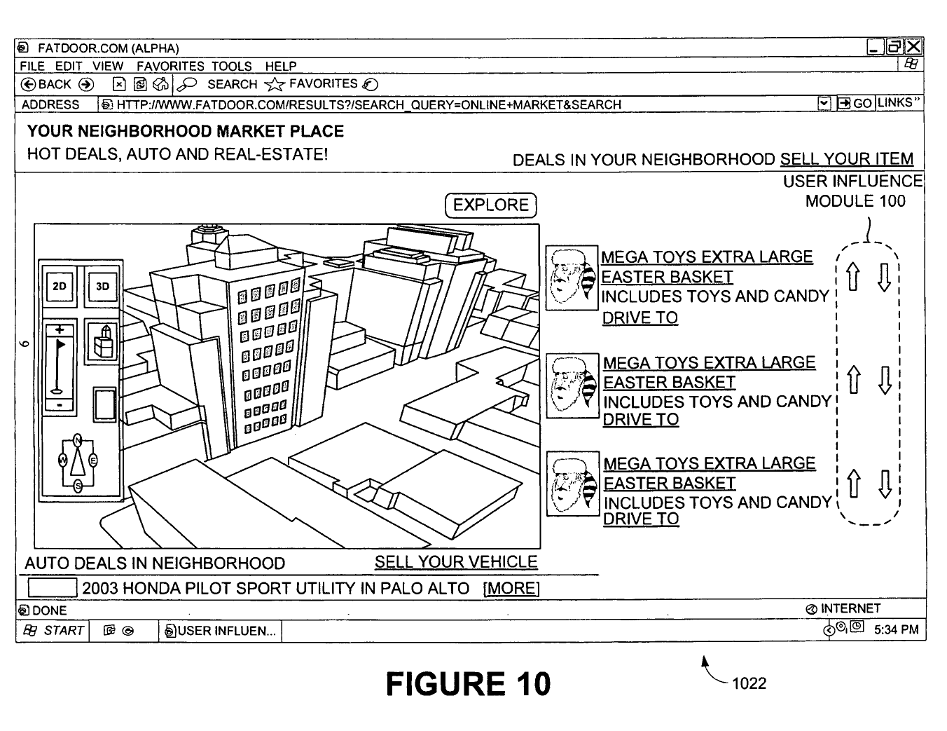

FIG. 10 is a user interface view of a central module 1022 illustrating ordering of deals in the neighborhood, according to one embodiment. Particularly, FIG. 10 illustrates the user influence module 100, according to one embodiment.

The user influence module 100 may enable the average users to shuffle a search result obtained in a Fatdoor® webpage based on a weighted preference of relevant links by the average users to obtain a more relevant search result.

In the example embodiment illustrated in FIG. 10, the user interface view displays a neighborhood marketplace in the three dimensional map that enables users to perform business deals with each other. The central module 1022 may enable the average users to post comments, advertise, buy and/or sell items in the neighborhood. The average users may also order listings displayed on right side of the user interface view using the user influence module 100 to contribute a perspective on the relative order of the listings.

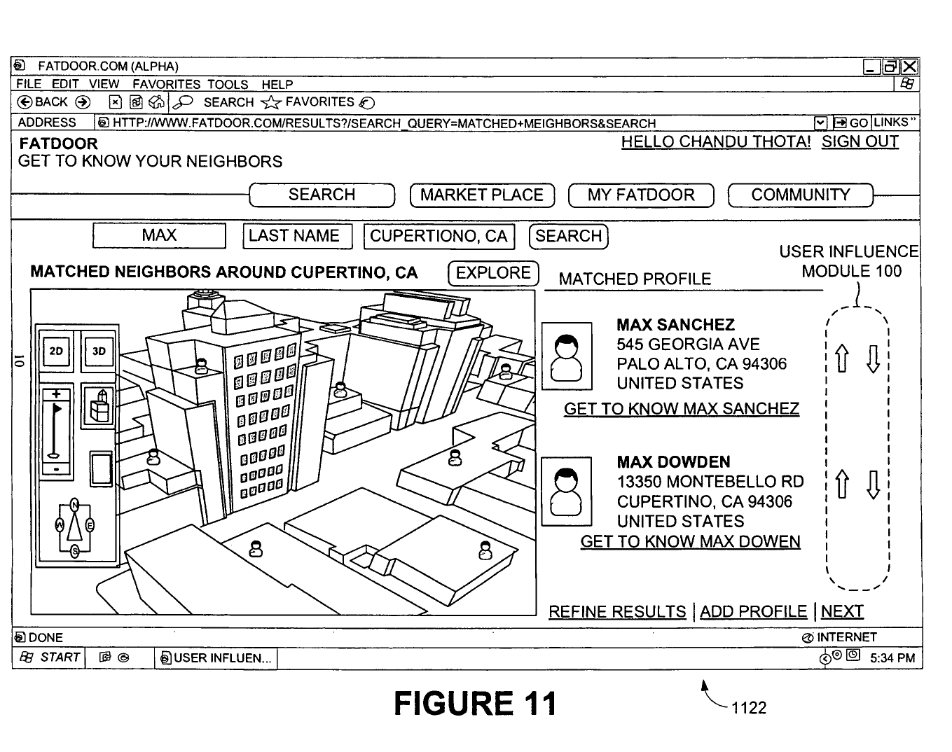

FIG. 11 is a user interface view of a central module 1122 illustrating ordering of matched profiles, according to one embodiment. Particularly, FIG. 11 illustrates the user influence module 100, according to one embodiment. The user influence module 100 may enable the average users to shuffle profiles (e.g., matching a search keyword provided by a user) displayed as a search result in a Fatdoor® webpage using the up arrow and/or down arrow.

In the example embodiment illustrated in FIG. 11, the user interface view displays the three dimensional map view, where the users may find their matched neighbors. The matched profiles on right hand side of the central module 1122 displays search results obtained when any user enters a search keyword (e.g., “Max”) in Fatdoor® search engine. The average users may shuffle the matched profiles in the search result using the up arrow and/or the down arrow provided in the user influence module 100.

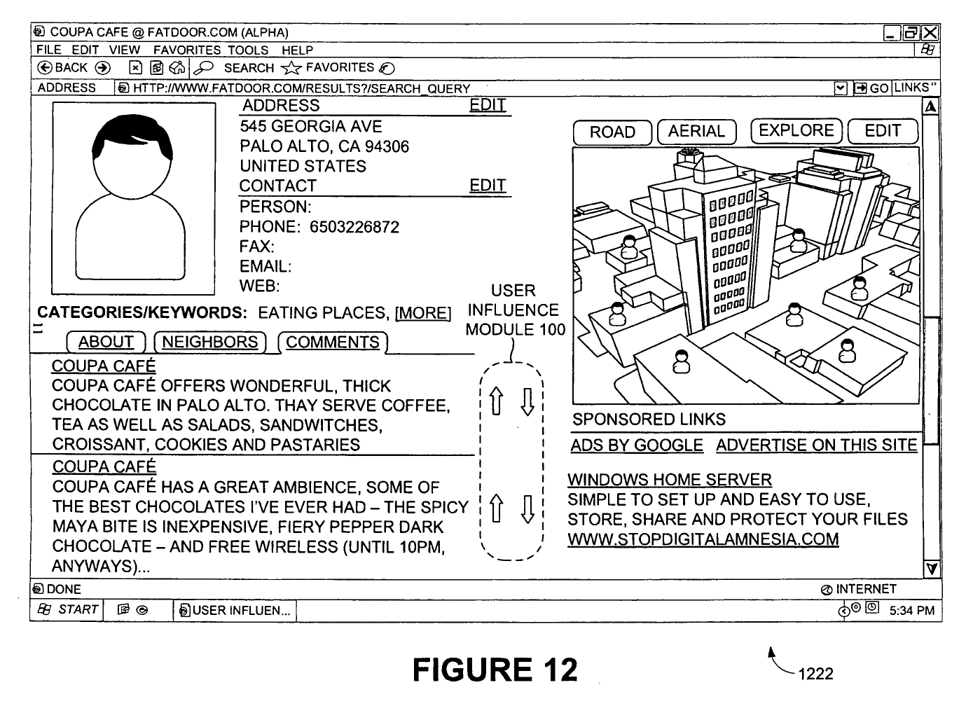

FIG. 12 is a user interface view of a central module 1222 illustrating ordering of comments associated with a user profile, according to one embodiment. Particularly, FIG. 12 illustrates the user influence module 100, according to one embodiment.

The user influence module 100 may enable the average users to shuffle a search result obtained in a Fatdoor® search result web page based on a weighted preference of relevant links.

In the example embodiment illustrated in FIG. 12, the user interface view displays the search result obtained when any user enters a search keyword (e.g., “Coupa café”) in the Fatdoor® search engine. The central module 1222 also enables the embedding of certain advertisement links along with generation of the search results. The average users may shuffle order of the links (e.g., comments about the Coupa café, etc.) based on their weighted preference through the user influence module 100.

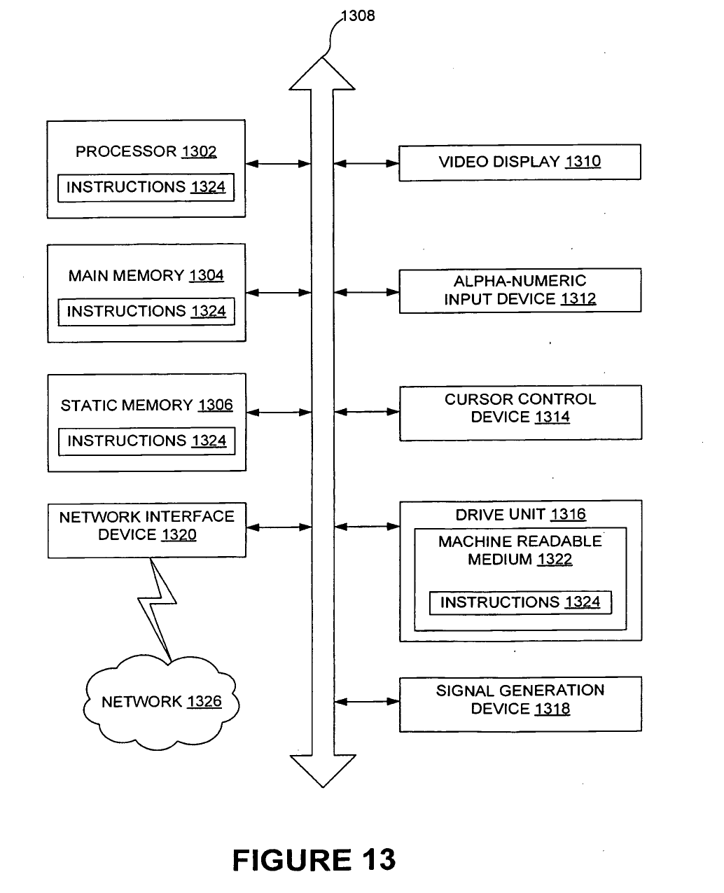

FIG. 13 is a diagrammatic system view 1300 of a data processing system in which any of the embodiments disclosed herein may be performed, according to one embodiment. Particularly, the diagrammatic system view 1300 of FIG. 13 illustrates a processor 1302, a main memory 1304, a static memory 1306, a bus 1308, a video display 1310, an alpha-numeric input device 1312, a cursor control device 1314, a drive unit 1316, a signal generation device 1318, a network interface device 1320, a machine readable medium 1322, instructions 1324 and a network 1326, according to one embodiment.

The diagrammatic system view 1300 may indicate a personal computer and/or the data processing system in which one or more operations disclosed herein are performed. The processor 1302 may be a microprocessor, a state machine, an application specific integrated circuit, a field programmable gate array, etc. (e.g., Intel® Pentium® processor). The main memory 1304 may be a dynamic random access memory and/or a primary memory of a computer system.

The static memory 1306 may be a hard drive, a flash drive, and/or other memory information associated with the data processing system. The bus 1308 may be an interconnection between various circuits and/or structures of the data processing system. The video display 1310 may provide graphical representation of information on the data processing system. The alpha-numeric input device 1312 may be a keypad, a keyboard and/or any other input device of text (e.g., a special device to aid the physically challenged). The cursor control device 1314 may be a pointing device such as a mouse.

The drive unit 1316 may be the hard drive, a storage system, and/or other longer term storage subsystem. The signal generation device 1318 may be a bios and/or a functional operating system of the data processing system. The network interface device 1320 may be a device that may perform interface functions such as code conversion, protocol conversion and/or buffering required for communication to and from the network 1326. The machine readable medium 1322 may provide instructions on which any of the methods disclosed herein may be performed. The instructions 1324 may provide source code and/or data code to the processor 1302 to enable any one/or more operations disclosed herein.

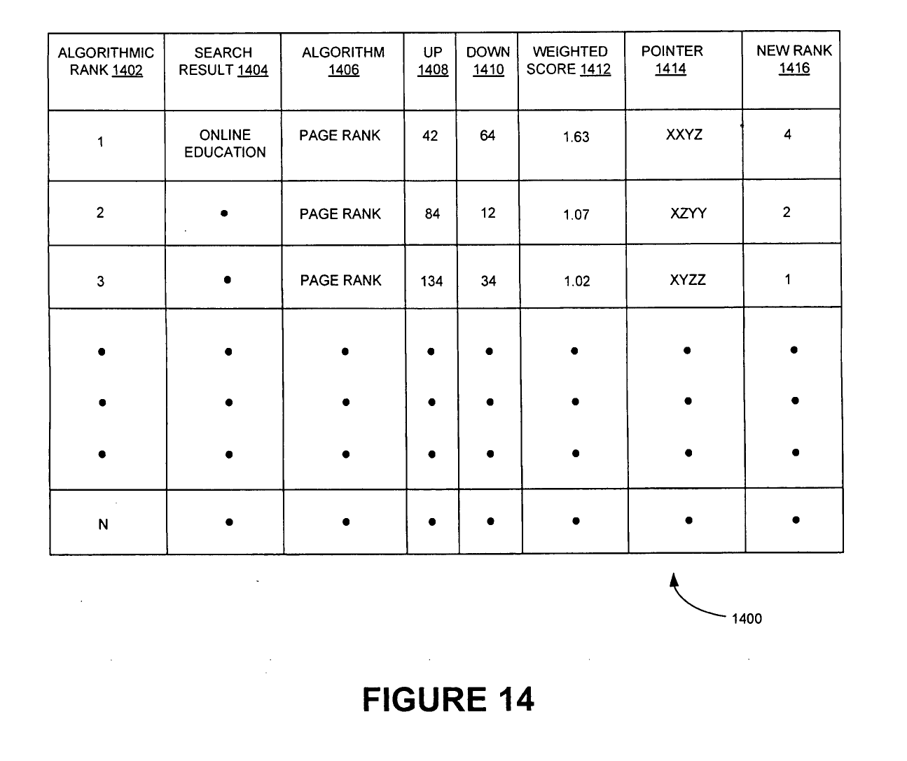

FIG. 14 is a table view 1400 displaying ranking details of various links in a search result, according to one embodiment. Particularly, FIG. 14 illustrates an algorithmic rank field 1402, a search result field 1404, an algorithm field 1406, an up field 1408, a down field 1410, a weighted score field 1412, a pointer field 1414 and a new rank field 1416, according to one embodiment.

The algorithmic rank field 1402 may display ranks of the various links in the search result. The search result field 1404 may display the links obtained when the search keyword (e.g., online education) is entered by the users in the search query. The algorithm field 1406 may display an algorithm (e.g., the page rank algorithm, the influence based algorithm, the human editor rank algorithm, the temporal existence algorithm, the user-generated premium algorithm and/or the specialized category search algorithm, etc.) used to rank individual ones of a set of links in the search result.

The up field 1408 may indicate a count of a number of times average user(s) select an up arrow to change order of links in the search result. The down field 1410 may indicate a count of a number of times average user(s) select a down arrow to change order of links in the search result. The weighted score field 1412 may display a score (e.g., a weighting factor) applied to the links in the search result based on a user suggested ranking. The pointer field 1414 may indicate order preferences given by the various users to the various links in the search result. The new rank field 1416 may display the user suggested ranking generated using the user influence module 100.

In the example embodiment illustrated in FIG. 14, the algorithmic rank field 1402 displays “1” in the first row, “2” in the second row and “3” in the third row of the algorithmic rank field 1402 column (e.g., 1, 2 and 3 indicates the ranks of links as obtained when the search keyword is entered by the users). The search result field 1404 displays “online education” in the first row of the search result field 1404 column. The algorithm field 1406 displays “Page rank” in the first row, “Page rank” in the second row and “Page rank” in the third row of the algorithm field 1406 column (e.g., the page rank algorithm is used by the average users to rank the links associated with the search result). The up field 1408 displays “42” in the first row indicating that first link was moved 42 times up by the average users, “84” in the second row indicating that second link was moved 84 times up and “134” in the third row of the up field 1408 column indicating that third link was moved 134 times up by the average users.

The down field 1410 displays “64” in the first row indicating that the first link was moved 64 times down by the average users, “12” in the second row indicating that the second link was moved down 12 times and “34” in the third row of the down field 1410 column indicating that the third link was moved down 34 times by the average users. The weighted score field 1412 displays “1.63” in the first row indicating that the weighted score of the first link as given by the average users, “1.07” in the second row indicates the weighted score of the second link and “1.02” in the third row of the weighted score field 1412 column indicates the weighted score of the third link as given by the average users. The pointer field 1414 displays “XXYZ” in the first row, “XZYY” in the second row and “XYZZ” in the third row of the pointer field 1414 column (e.g., XXYZ, XZYY and XYZZ indicates the suggested order of links in the search result). The new rank field 1416 displays “4” in the first row, “2” in the second row and “1” in the third row of the new rank field 1416 column (e.g., 4, 2 and 1 indicates the new rank of the links as suggested by the average users.

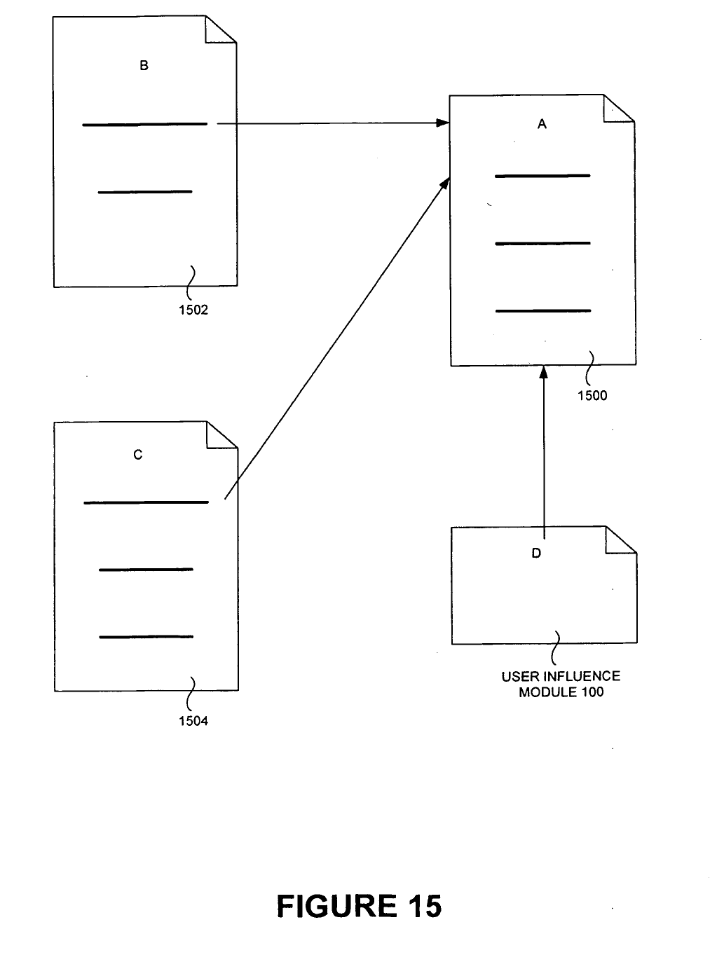

FIG. 15 is a schematic representation of a typical relationship between three hypertext documents and the user influence module D 100, according to one embodiment. Particularly, FIG. 15 illustrates the user influence module D 100, a hypertext document A 1500, a hypertext document B 1502 and a hypertext document C 1504, according to one embodiment.

The user influence module D 100 may enable a user to contribute a new perspective on relative order of the search result as determined by the users based on the weighted preference of relevant links. The hypertext documents A 1500, B 1502 and C 1504 may include links relevant to the search query.

In the example embodiment illustrated in FIG. 15, the first link in the hypertext document B 1502 points to the hypertext document A 1500. Similarly, the first link in the hypertext document C 1504 points to the hypertext document A 1500. Thus, the hypertext documents B 1502 and C 1504 are backlinks of the hypertext document A 1500. The hypertext document A 1500 is a forward link of the hypertext documents B 1502 and C 1504. The user influence module D 100 interacts with the hypertext document A 1500 allowing the average users to rank the various links present in the hypertext documents such that the user suggested ordering of the search result may be obtained.

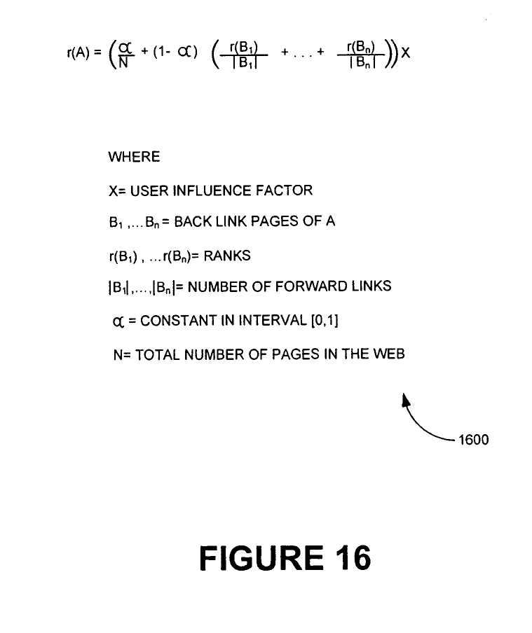

FIG. 16 is an example formula 1600 using a page rank algorithm, according to one embodiment. The rank ‘r(A)’ of a page A (e.g., the hypertext document A 1500 of FIG. 15) is defined by the formula

r(A)=(α/N+(1−α)(r(B₁)/|B₁|+ . . . +r(Bₙ)/|Bₙ|))X

where,
B₁, . . . , Bₙ are the backlink pages of A,
r(B₁), . . . , r(Bₙ) are the ranks of B₁, . . . , Bₙ respectively,
|B₁|, . . . , |Bₙ| are the numbers of forward links of B₁, . . . , Bₙ respectively,
α is a constant in the interval [0,1],
N is the total number of pages in the web and
X is the user influence factor, according to one embodiment.

The rank of a page may be a measure of importance of the page. The rank of the page may be interpreted as the probability that a surfer (e.g., a user) will be at the page after following a large number of forward links. The ranks form a probability distribution over web pages, so that the sum of ranks over all web pages is unity. The constant α in the formula is interpreted as the probability that the web surfer will jump randomly to any web page instead of following the forward link. Page ranks for all the pages may be calculated using a simple iterative algorithm and corresponds to principal eigenvector of normalized link matrix of the web.

The iteration process can be understood as a steady-state probability distribution calculated from a model of a random surfer. The model includes an initial N-dimensional probability distribution vector p₀ where each component p₀[i] gives the initial probability that the random surfer will start at a node i and an N×N transition probability matrix A where each component A[i][j] gives the probability that the surfer will move from node i to node j.

The search engine is used to locate documents that match the specified search criteria, either by searching full text, or by searching titles only. In addition, the search may include anchor text associated with backlinks to the page. Once a set of documents is identified that match the search terms, the list of documents may be then sorted with high ranking documents first and low ranking documents last.

In the example embodiment illustrated in FIG. 16, the user influence factor X is deployed. The results generated by the iterative process may be further fine tuned according to the preference of the average user by using a suitable input for X. The search result may be shuffled and reorganized to suit the needs of the particular average user according to the value used for X. Hence, the end user may be allowed to modify the search to suit his/her specific needs making the search experience more user-friendly and meaningful. In this way, the model may better approximate human usage and/or rank documents in a database by modeling human behavior when surfing the web in a better manner.

In one example embodiment, the quality of results from web search engines (e.g., Google®, Yahoo®, etc.) may be enhanced. For example, an individual user influenced ranking method may be integrated into a web search engine to produce results far superior to existing methods.

In the example embodiment illustrated in FIG. 16, the page ranking algorithm may be applied to determine the search result on a periodic basis while retaining an influence of the aggregate relative weight influence of the individual users providing feedback on the specific links in the search result.

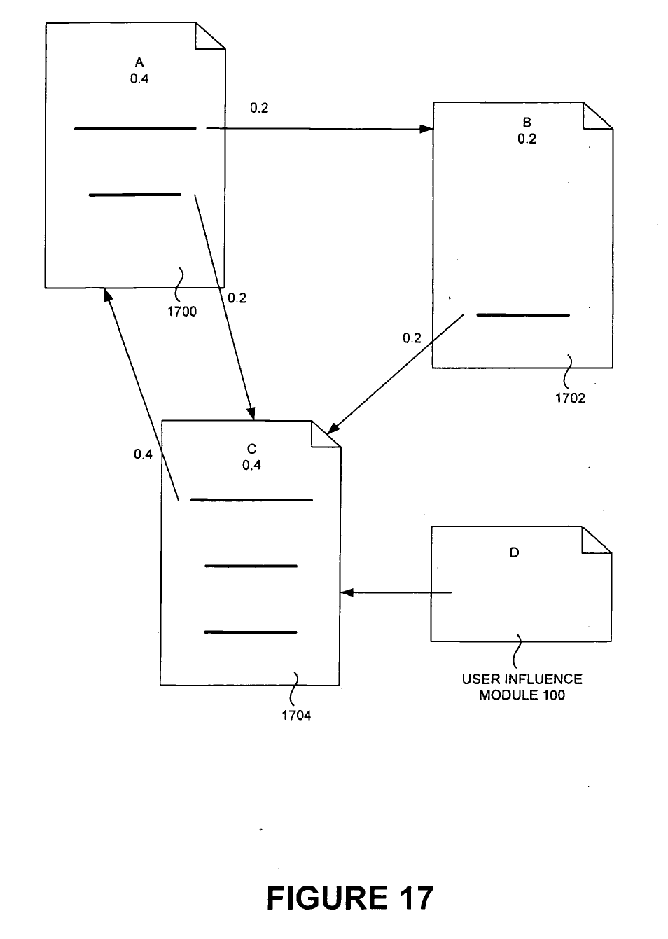

FIG. 17 is a schematic representation of a ranking method of hypertext documents using the user influence module D 100, according to one embodiment. Particularly, FIG. 17 illustrates the user influence module D 100, a hypertext document A 1700, a hypertext document B 1702 and a hypertext document C 1704, according to one embodiment.

The user influence module D 100 may enable the user to contribute a new perspective on relative order of the search result as determined by the users based on a weighted preference of relevant links. The hypertext documents A 1700, B 1702 and C 1704 may include links relevant to the search query.

In the example embodiment illustrated in FIG. 17, each of the hypertext documents includes links represented by horizontal dark lines. The value written below the label A namely 0.4 represents the rank r(A) of the hypertext document A 1700. The value written below the label B namely 0.2 represents the rank r(B) of the hypertext document B 1702. The value written below the label C namely 0.4 represents the rank r(C) of the hypertext document C 1704.

For ease of illustration we assume that r=0. In the present example, the hypertext document A 1700 has a single backlink to the hypertext document C 1704 and this is the only forward link of the hypertext document C 1704, so

r(A)=r(C).

The hypertext document B 1702 has a single backlink to the hypertext document A 1700, but this is one of two forward links of the hypertext document A 1700, so

r(B)=r(A)/2.

The hypertext document C 1704 has two backlinks. One backlink is to the hypertext document B 1702 and this is the only forward link of hypertext document B 1702. The other backlink is to document A 1700 via the other of the two forward links from the hypertext document A 1700. Thus

r(C)=r(B)+r(A)/2

Since the sum of ranks over all web pages is unity,

r(A)+r(B)+r(C)=1.

Substituting from above relations, r(A)=0.4, r(B)=0.2 and r(C)=0.4.

Although a typical value for α is about 0.1, if for simplicity we set α=0.5 (which corresponds to a 50% chance that a surfer will randomly jump to one of the three pages rather than following a forward link), then the mathematical relationships between the ranks may become more complicated.

In particular, we then have

r(A)=⅙+r(C)/2,

r(B)=⅙+r(A)/4 and

r(C)=⅙+r(A)/4+r(B)/2.

The solution in the case is r(A)= 14/39, r(B)= 10/39 and r(C)= 15/39.

In practice, there may be millions of documents and hence, it may not be possible to find the solution to millions of equations by inspection. Accordingly, in a preferred embodiment an iterative procedure is used. At the initial state we may simply set all the ranks equal to 1/N. The formulas may be then used to calculate a new set of ranks based on the existing ranks. In the case of millions of documents, sufficient convergence typically takes on the order of 100 iterations.

The user influence module D 100 interacts with the hypertext document C 1704 allowing the average users to rank various links present in the hypertext documents (e.g., the hyper text document 1700A, the hypertext document B 1702 and the hypertext document C 1704) such that a user suggested ordering of the search result may be obtained.

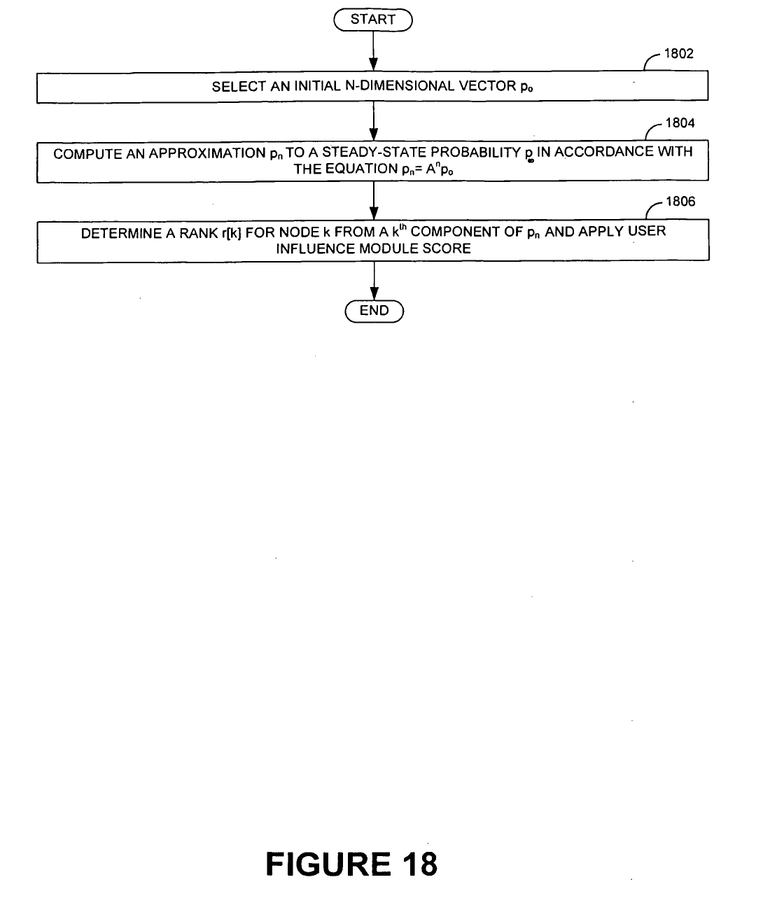

FIG. 18 is a process flow of a computer implemented method for calculating an importance rank for N linked nodes (e.g., a node may correspond to a web page document) of a linked database, according to one embodiment. In operation 1802, an initial N-dimensional vector p₀ may be selected. In operation 1804, an approximation pₙ to a steady-state probability p_{∞} may be computed in accordance with the equation pₙ=Aⁿp₀. In operation 1806, a rank r[k] for node k may be determined from a k^{th} component of pₙ and a user influence module score may be applied.

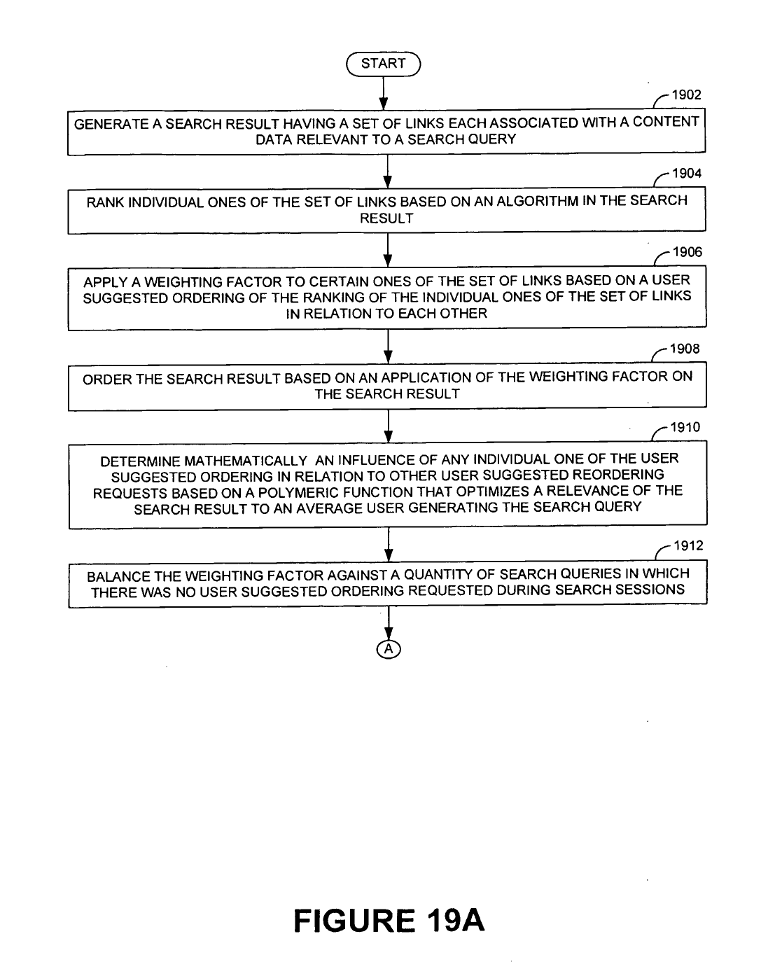

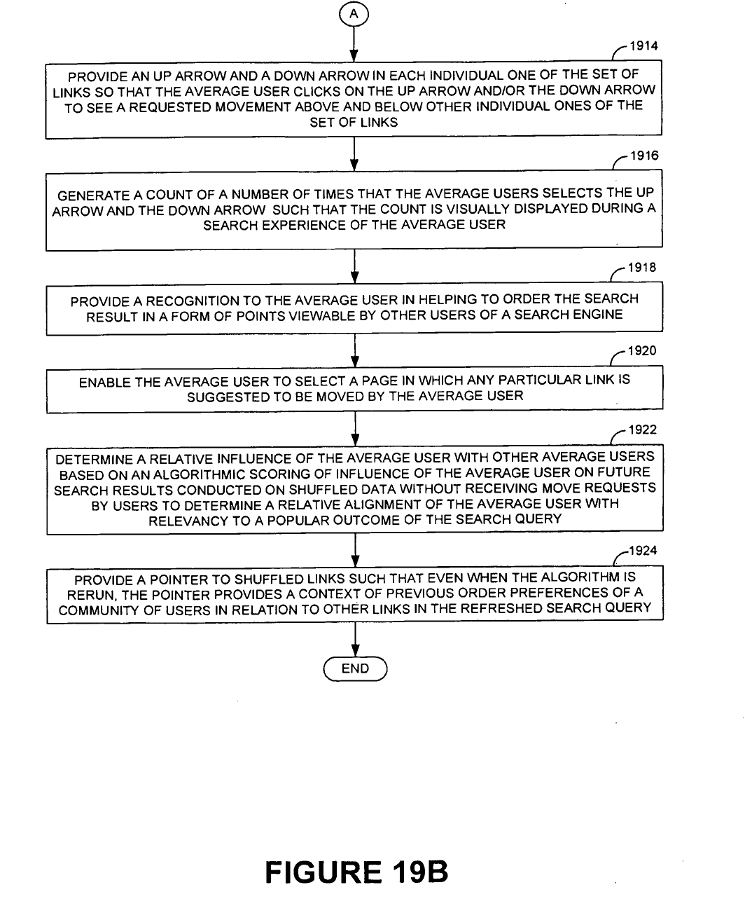

FIG. 19A is a process flow of generating a user suggested ordering of links in a search result, according to one embodiment. In operation 1902, a search result having a set of links each associated with a content data relevant to a search query may be generated (e.g., using the search module 104 of FIG. 1). In operation 1904, individual ones of the set of links may be ranked (e.g., using the function module 110 of FIG. 1) based on an algorithm in the search result. In operation 1906, a weighting factor may be applied (e.g., using the factor module 102 of FIG. 1) to certain ones of the set of links based on a user suggested ordering of the ranking of the individual ones of the set of links in relation to each other.

In operation 1908, the search result may be ordered based on an application of the weighting factor (e.g., using the factor module 102 of FIG. 1) on the search result. In operation 1910, an influence of any individual one of the user suggested ordering in relation to other user suggested reordering requests may be determined mathematically (e.g., using the user influence module 100 of FIG. 1) based on a polymeric function that optimizes a relevance of the search result to an average user generating the search query. In operation 1912, the weighting factor may be balanced against a quantity of search queries (e.g., using the user influence module 100 of FIG. 1) in which there was no user suggested ordering requested during search sessions.

FIG. 19B is a continuation of the process flow of FIG. 19A illustrating additional processes, according to one embodiment. In operation 1914, an up arrow and a down arrow may be provided (e.g., through the higher module 118 and the lower module 120 of FIG. 1) in each individual one of the set of links so that the average user clicks on the any one of the up arrow and the down arrow to see the requested movement above and/or below other individual ones of the set of links. In operation 1916, a count of a number of times that the average users select the up arrow and the down arrow may be generated (e.g., through the pointer module 106 of FIG. 1) such that the count is visually displayed during a search experience of the average user. In operation 1918, recognition may be provided (e.g., through the user influence module 100 of FIG. 1) to the average user in helping to order the search result in a form of points viewable by other users of a search engine.

In operation 1920, the average user may be enabled to select a page (e.g., using the user influence module 100 of FIG. 1) in which any particular link is suggested to be moved by the average user. In operation 1922, a relative influence of the average user with other average users may be determined (e.g., using the user influence module 100 of FIG. 1) based on an algorithmic scoring of influence of the average user on future search results conducted on shuffled data without receiving move requests by users to determine a relative alignment of the average user with relevancy to a popular outcome of the search query. In operation 1924, a pointer may be provided (e.g., using the pointer module 106 of FIG. 1) to shuffled links such that even when the algorithm is rerun, the pointer provides a context of previous order preferences of a community of users in relation to other links in the refreshed search query.

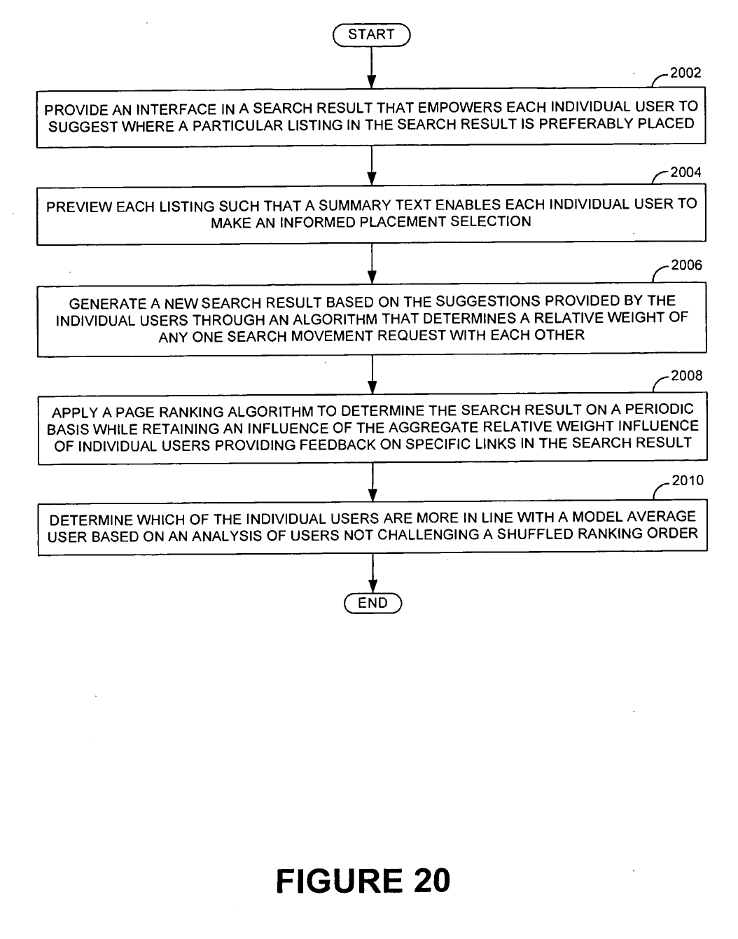

FIG. 20 is a process flow of providing an interface to shuffle a search result, according to one embodiment. In operation 2002, an interface may be provided (e.g., using the user influence module 100 of FIG. 1) in a search result that empowers each individual user to suggest where a particular listing in the search result is preferably placed. In operation 2004, each listing may be previewed such that a summary text enables each individual user to make an informed placement selection. In operation 2006, a new search result may be generated (e.g., using the refresh module 112 of FIG. 1) based on suggestions provided by individual users through an algorithm that determines a relative weight of any one search movement request with each other.

In operation 2008, a page ranking algorithm may be applied (e.g., using the function module 110 of FIG. 1) to determine the search result on a periodic basis while retaining an influence of the aggregate relative weight influence of individual users providing feedback on specific links in the search result. In operation 2010, it may be determined (e.g., using the user influence module 100 of FIG. 1) which of the individual users are more in line with a model average user based on an analysis of users not challenging a shuffled ranking order.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and/or electrical circuits (e.g., Application Specific Integrated Circuitry (ASIC) and/or in Digital Signal Processor (DSP) circuitry). For example, the user influence module 100, the factor module 102, the search module 104, the pointer module 106, the advertising module 108, the function module 110, the refresh module 112, the claimable wiki module 114, the category search module 116, the higher module 118, the lower module 120, the central module 122 and the other modules of FIGS. 1-20 may be enabled using a user influence circuit, a factor circuit, a search circuit, a pointer circuit, an advertising circuit, a function circuit, a refresh circuit, a claimable wiki circuit, a category search circuit, a higher circuit, a lower circuit, a central circuit and other circuits using one or more of the technologies described herein.

In addition, it will be appreciated that the various operations, processes and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
generating a search result having a set of links, each associated with a content data relevant to a search query;
ranking individual ones of the set of links based on an algorithm in the search result;
applying a weighting factor to certain ones of the set of links based on a user suggested ordering of the ranking of the individual ones of the set of links in relation to each other; and
ordering the search result based on an application of the weighting factor on the search result.

2. The method of claim 1 further comprising mathematically determining an influence of any individual one of the user suggested ordering in relation to other user suggested reordering requests based on a polymeric function that optimizes a relevance of the search result to an average user generating the search query.

3. The method of claim 2 further comprising balancing the weighting factor against a quantity of search queries in which there was no user suggested ordering requested during search sessions.

4. The method of claim 3 wherein the algorithm is at least one of a page rank algorithm, an influence based algorithm, a human editor rank algorithm, a temporal existence algorithm, a user-generated content premium algorithm, and a specialized category search algorithm.

5. The method of claim 1 further comprising providing an up arrow and a down arrow in each individual one of the set of links so that the average user clicks on at least one of the up arrow and the down arrow to see a requested movement above and below other individual ones of the set of links.

6. The method of claim 5 further comprising generating a count of a number of times that the average users select the up arrow and the down arrow such that the count is visually displayed during a search experience of the average user.

7. The method of claim 6 further comprising providing a recognition to the average user in helping to order the search result in a form of points viewable by other users of a search engine.

8. The method of claim 7 further comprising enabling the average user to select a page in which any particular link is suggested to be moved by the average user.

9. The method of claim 8 further comprising determining a relative influence of the average user with other average users based on an algorithmic scoring of influence of the average user on future search results conducted on shuffled data without receiving move requests by users to determine a relative alignment of the average user with relevancy to a popular outcome of the search query.

10. The method of claim 1 further comprising providing a pointer to shuffled links such that even when the algorithm is rerun, the pointer provides a context of previous order preferences of a community of users in relation to other links in the refreshed search query.

11. The method of claim 1 in a form of a machine-readable medium embodying a set of instructions that, when executed by a machine, causes the machine to perform the method of claim 1.

12. A system comprising:
a user influence module to shuffle a search result based on a weighted preference of relevant links as determined by a plurality of users contributing a perspective on the relative order of the search result;
a function module to apply a page rank algorithm in determining a relative order of links in the search result responsive to a search query;
a factor module to apply a weighting factor to individual links in the search result such that certain ones of the individual links are prioritized before other links; and
a search module to generate the search result that dynamically adjusts as different users contribute perspectives through the user influence module.

13. The system of claim 12 further comprising an advertising module to embed certain links adjacent to the search result based on bidding between advertisers seeking impressions adjacent to the search result.

14. The system of claim 13 further comprising a category search module to enhance relevancy of the search results based on a category being searched through an application of different algorithms optimized to a category search employed.

15. The system of claim 14 further comprising a claimable wiki module to embed in the search results, a section relevant to the search query associated with a claimable people profile wiki, a business profile wiki, an organization claimable profile wiki, a places wiki, and an other object wiki.

16. The system of claim 15 further comprising a pointer module to index and capture shuffled links across a plurality of iterations of the search query with a search algorithm.

17. The system of claim 16 further comprising a refresh module to apply the pointer module each time the search algorithm is reapplied even when certain links in the search result are activated, deactivated, modified, added, and deleted based on a reindexing of Internet through the search algorithm.

18. A method comprising:
providing an interface in a search result that empowers each individual user to suggest where a particular listing in the search result is preferably placed;
previewing each listing such that a summary text enables each individual user to make an informed placement selection; and
generating a new search result based on a plurality of suggestions provided by the individual users through an algorithm that determines a relative weight of any one search movement request with each other.

19. The method of claim 18 further comprising applying a page ranking algorithm to determine the search result on a periodic basis while retaining an influence of an aggregate relative weight influence of the individual users providing feedback on specific links in the search result.

20. The method of claim 19 further comprising determining which of the individual users are more in line with a model average user based on an analysis of users not challenging a shuffled ranking order.
